(19) United States
(12) Patent Application Publication
(10) Pub. No.: US 2026/0257399 A1
(43) Pub. Date: Sep. 3, 2026

(54) SYSTEM AND METHOD FOR MANUFACTURING BOARDS WITH ON-LINE DEFECT DETECTION SYSTEM WITH ILLUMINATED MACHINE VISION

(71) Applicant: United States Gypsum Company, Chicago, IL (US)

(72) Inventor: Ronald John Koval, Aurora, IL (US)

(73) Assignee: United States Gypsum Company, Chicago, IL (US)

(21) Appl. No.: 19/551,263

(22) Filed: Feb. 26, 2026

Related U.S. Application Data
(60) Provisional application No. 63/765,605, filed on Mar. 1, 2025.

(51) Int. Cl. B28B 17/00; B28B 11/16; B65G 43/08; B65G 47/42; H04N 23/74; B28B 19/00

(52) U.S. Cl. CPC B28B 17/0072; B28B 11/16; B65G 43/08; B65G 47/42; H04N 23/74; B28B 19/0092; B65G 2201/022; B65G 2203/0208; B65G 2203/041

(57) ABSTRACT

Embodiments of a system and a method for detecting a defect in a board can be used in connection with the manufacture of products, including cementitious board products such as gypsum wallboard, for example. Such systems and methods can include a light source mounted in a fixture configured to focus the light beam emitted by the light source onto the board being produced so that a camera/computer vision system can generate an image for use by a controller to detect a defect condition during the continuous manufacture of the board.

### CROSS-REFERENCE TO RELATED APPLICATION

This patent application claims the benefit of priority to U.S. Provisional Patent Application No. 63/765,605, filed March 1, 2025, and entitled, “System and Method for Manufacturing Boards With On-Line Defect Detection System With Illuminated Machine Vision,” which is incorporated in its entirety herein by this reference.

### BACKGROUND

The present disclosure relates to continuous board manufacturing processes and, more particularly, to a system and method for detecting quality defects of a cementitious article during its manufacture.

In many types of cementitious articles, set gypsum (calcium sulfate dihydrate) is often a major constituent. For example, set gypsum is a major component of end products created by use of traditional plasters (e.g., plaster-surfaced internal building walls), and also in faced gypsum board employed in typical drywall construction of interior walls and ceilings of buildings. In addition, set gypsum is the major component of gypsum/cellulose fiber composite boards and products, as described in U.S. Patent No. 5,320,677, for example. Also, many specialty materials, such as materials useful for modeling and mold-making, produce products that contain major amounts of set gypsum. Typically, such gypsum-containing cementitious products are made by preparing a mixture of calcined gypsum (calcium sulfate alpha or beta hemihydrate and/or calcium sulfate anhydrite), water, and other components, as appropriate to form cementitious slurry. In the manufacture of cementitious articles, the cementitious slurry and desired additives are often blended in a continuous mixer, as described in U.S. Patent No. 3,359,146, for example.

In a typical cementitious article manufacturing process such as wallboard, gypsum board is produced by uniformly dispersing calcined gypsum (commonly referred to as “stucco”) in water to form aqueous calcined gypsum slurry. The aqueous calcined gypsum slurry is typically produced in a continuous manner by inserting stucco and water and other additives into a mixer which contains means for agitating the contents to form a uniform gypsum slurry. The slurry is continuously directed toward and through a discharge outlet of the mixer and into a discharge conduit connected to the discharge outlet of the mixer. Aqueous foam can be combined with the aqueous calcined gypsum slurry in the mixer and/or in the discharge conduit. A stream of foamed slurry passes through the discharge conduit from which it is continuously deposited onto a moving web of cover sheet material supported by a forming table.

The foamed slurry is allowed to spread over the advancing web. A second web of cover sheet material is applied to cover the foamed slurry and form a sandwich structure of a continuous wallboard preform, which is subjected to forming, such as at a conventional forming station, to obtain a desired thickness.

With the core of the board being made from increasingly less dense gypsum slurry, it can be desirable to position a more dense and/or stronger slurry against one or more of the cover sheet faces (commonly referred to as a “skim coat”) and/or at the lateral edges of the board. The skim coat can help enhance the bond between the cover sheet material and the dried cementitious material. The edge material can help allow for the handling of the board without excessive damage to its edges and also to allow for the secure attachment of the board to a framing structure via fasteners located at the edges of the board.

The calcined gypsum reacts with the water in the wallboard preform and sets as a conveyor moves the wallboard preform down a manufacturing line. The wallboard preform is cut into segments at a point along the line where the preform has set sufficiently. The segments are flipped over, dried (e.g., in a kiln) to drive off excess water, and processed to provide the final wallboard product of desired dimensions. The aqueous foam produces air voids in the set gypsum, thereby reducing the density of the finished product relative to a product made using a similar slurry but without foam.

During the manufacture of the cementitious board, surface defects can occur in many variations at the edges and in the field surface, including cracks, blows, and facer peels. These defects can vary from significant depths to subtle, shallow depths, such as a ripple-like defect commonly referred to as “cockles.” There is a continued need in the art to provide additional solutions to enhance the production of cementitious boards. For example, there is a continued need for techniques for detecting quality defects that occur during continuous manufacture of cementitious board.

It will be appreciated that this background description has been created by the inventors to aid the reader and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims and not by the ability of any disclosed feature to solve any specific problem noted herein.

### SUMMARY

In one aspect, the present disclosure is directed to embodiments of a system for manufacturing a cementitious board including a system for detecting a defect in the cementitious board. For example, in one embodiment, a system for manufacturing a cementitious board is described which includes a conveyor for conveying the cementitious board along a machine direction and a defect detection system having an imaging device for generating image data in a field of view corresponding to a portion of the cementitious board as the cementitious board is conveyed along the machine direction and a light assembly with a light source and a fixture for receiving the light source therein and for reflecting at least a portion of the light beam emitted by the light source upon at least a portion of the field of view.

In one embodiment, a system for manufacturing a cementitious board includes a forming station, a conveyor, and a defect detection system. The cementitious board has a pair of edges.

The forming station is configured to form the cementitious board such that the cementitious board is within a predetermined thickness range. The conveyor is configured to convey the cementitious board along a machine direction away from the forming station such that the edges of the cementitious board extend along the machine direction and are disposed in lateral spaced relationship to each other along a cross-machine direction. The cross-machine direction is perpendicular to the machine direction.

The defect detection system includes an imaging device, a light assembly, and a controller. The imaging device is disposed downstream of the forming station along the machine direction. The imaging device is positioned relative to the conveyor and configured to generate image data within a field of view corresponding to a portion of the cementitious board as the cementitious board is conveyed past the imaging device. The light assembly has a light source configured to generate a light beam and a fixture configured to receive the light source therein and to reflect at least a portion of the light beam emitted by the light source so that the light beam is projected onto the board within the field of view of the imaging device. The controller is in operable arrangement with the imaging device to receive image data therefrom. The controller is configured to generate a control signal in response to the image data meeting a defect condition.

In another aspect of the present disclosure, embodiments of a method of manufacturing a cementitious board are described that include detecting a defect in the cementitious board. For example, in one embodiment, a method of manufacturing a cementitious board includes detecting a defect in the cementitious board using a defect detection system having an imaging device and a light assembly with a light source and a fixture for receiving the light source therein and for reflecting at least a portion of the light beam emitted by the light source upon at least a portion of the field of view from which the imaging device generates image data.

In one embodiment, a method of manufacturing a cementitious board includes conveying the cementitious board along a machine direction away from a forming station. The cementitious board has a pair of edges disposed in lateral spaced relationship to each other along a cross-machine direction, which is perpendicular to the machine direction. The edges of the cementitious board extend along the machine direction.

An imaging device, which is disposed downstream of the forming station along the machine direction, is used to generate image data within a field of view corresponding to a portion of the cementitious board as the cementitious board is conveyed past the imaging device. A light source mounted in a fixture is operated to emit a light beam that strikes the board within the field of view of the imaging device. The fixture reflects at least a portion of the light beam emitted by the light source.

Image data are transmitted from the imaging device to a controller. The controller is used to determine whether a defect condition has occurred using the image data and, in response to so determining a defect condition has occurred, to generate a control signal.

Further and alternative aspects and features of the disclosed principles will be appreciated from the following detailed description and the accompanying drawings. As will be appreciated, the systems and techniques for detecting a defect in a cementitious board disclosed herein are capable of being carried out and used in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a fragmentary perspective view of an embodiment of a system for manufacturing a cementitious board constructed in accordance with principles of the present disclosure which includes an embodiment of a defect detection system for detecting a defect in a board during continuous manufacture thereof which is constructed in accordance with principles of the present disclosure.

FIG. 2 is a fragmentary perspective view of an embodiment of a light assembly suitable for use in a defect detection system constructed in accordance with principles of the present disclosure.

FIG. 3 is a fragmentary perspective view as in FIG. 2 but with a light source of the light assembly illuminated.

FIG. 4 is a fragmentary perspective view of an embodiment of a light fixture suitable for use in a defect detection system constructed in accordance with principles of the present disclosure.

FIG. 5 is a fragmentary perspective view of another embodiment of a light fixture suitable for use in a defect detection system constructed in accordance with principles of the present disclosure, the light fixture having sidewalls with tapered distal ends.

FIG. 6 is a fragmentary perspective view of another embodiment of a light fixture suitable for use in a defect detection system constructed in accordance with principles of the present disclosure, the light fixture having parabolic-shaped sidewalls.

FIG. 7 is a sectional view of the light fixture of FIG. 6.

FIG. 8 is a perspective view of embodiments of a light fixture suitable for use in a defect detection system constructed in accordance with principles of the present disclosure, illustrating light fixtures with different connecting web base and sidewall dimensions and made from different materials.

FIG. 9 is a fragmentary perspective view of embodiments of a light source suitable for use in a defect detection system constructed in accordance with principles of the present disclosure.

FIG. 10 is a fragmentary perspective view of an embodiment of a light assembly suitable for use in a defect detection system constructed in accordance with principles of the present disclosure which is situated in a gap between conveyor belt segments.

FIG. 11 is a fragmentary perspective and schematic view of an embodiment of a system for manufacturing a cementitious board constructed in accordance with principles of the present disclosure which includes an embodiment of a defect detection system for detecting a defect in a board during continuous manufacture thereof which is constructed in accordance with principles of the present disclosure, illustrating a light source and a fixture for receiving the light source therein such that at least a portion of the light beam emitted by the light source is reflected by the fixture upon at least a portion of the field of view of the imaging device.

FIG. 12 is a fragmentary, schematic elevational view of an embodiment of a system for manufacturing a cementitious board in the form of a gypsum wallboard manufacturing line including an embodiment of a defect detection system for detecting a defect in a board during continuous manufacture thereof which is constructed in accordance with principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

The present disclosure provides various embodiments of a system and a method for detecting a defect in a board during continuous manufacture thereof that can be used in connection with the manufacture of products, including cementitious products, such as a fiber-reinforced gypsum wallboard, for example. Embodiments of a system and a method for detecting a defect (e.g., a crack or surface defect) in a board during continuous manufacture thereof following principles of the present disclosure can be used online in a continuous manufacturing process to effectively determine whether a defect is present within the board (e.g., gypsum wallboard) being produced and issue an operator alert when a threshold defect condition is detected.

Embodiments of a system and a method for detecting a defect in a board during continuous manufacture thereof that follow principles of the present disclosure can be used to produce an image of the board being produced under enhanced lighting conditions to improve the quality of the image for use by a controller to determine whether a defect condition is present. In embodiments, the image generated using principles of the present disclosure can be used to help monitor and/or control the quality of the board being made.

Embodiments of a system and a method for detecting a defect in a board during continuous manufacture thereof that follow principles of the present disclosure can include a conveyor for conveying the cementitious board along a machine direction and a defect detection system having an imaging device (e.g., a camera or computer vision system), a light assembly with a light source and a fixture for receiving the light therein and for focusing the light beam emitted by the light source by reflecting at least a portion of the light beam, and a controller. The imaging device is arranged with the moving conveyor to capture an image of a portion of the board passing through a field of view of the imaging device as the board is being conveyed along a machine direction by the conveyor. The controller is programmed with an image analysis program and is in operable arrangement with the imaging device to receive image data therefrom. The controller can be used to detect at least one defect condition. The appearance of the image from the imaging device can be enhanced by the light assembly. The fixture is configured to mechanically house the light source and to act as a reflector that concentrates the light emitted by the light source so that it is directionally projected onto the board to enhance defect visibility in the image data taken by the imaging device. The light assembly is configured to produce uniform lighting across the width of wall board line within the field of view of the imaging device to help produce enhanced image data for use by the defect detection system. In embodiments, the light emitted by the fixtured light source enhances the image generated by the imaging device to help allow the controller to detect a defect condition present in the image.

In embodiments, the light source can comprise a suitable “chip-on-board” (COB) or surface-mounted device (SMD) light-emitting diode (LED) light strip, for example. In embodiments, the light source comprises a suitable LED light strip which includes LEDs having a beam spread that directs light against the sidewalls of the fixture for reflection, thereby focusing the projected light beam onto the board. In embodiments, the light source comprises a suitable LED light strip which includes LEDs a beam spread of about 120°. In embodiments, the LED strip can be trimmed to a desired axial length so that the light assembly is longer than the width of the board being monitored. In embodiments, the fixture can comprise a U-shaped channel to direct the beam to a narrowed, directional beam. In embodiments, the fixture comprises a parabolic reflector with parabolic-shaped sidewalls. In embodiments, the fixture comprises a parabolic reflector within which the length of a LED light strip is mounted and having two parabolic contours positioned and configured to reflect the lateral portions of the LEDs’ light beam in the forward, center axis of the LEDs.

In embodiments, the controller can be programmed, in response to detecting a defect condition, to issue an upstream signal to make upstream manufacturing adjustment(s) and a downstream signal to make proper reject handling steps. In embodiments, a defect detection system constructed according to principles of the present disclosure includes a plurality of light sources mounted in a corresponding number of fixtures that are respectively disposed at different conveying points along the production line to inspect the quality of the board being produced at multiple points of the production line.

In one embodiment, a system for manufacturing a cementitious board includes a forming station, a conveyor, and a defect detection system. The defect detection system has an imaging device, a light assembly, and a controller with a non-transitory, computer-readable medium and a processor. The cementitious board has a pair of edges extending along a machine direction and in lateral offset relationship with each other along a cross-machine direction that is perpendicular to the machine direction.

The forming station is configured to form the cementitious board such that the cementitious board is within a predetermined thickness range. The conveyor is configured to convey the cementitious board along the machine direction away from the forming station such that the edges of the cementitious board extend along the machine direction and are disposed in lateral spaced relationship to each other along the cross-machine direction. The cross-machine direction is perpendicular to the machine direction.

The imaging device is disposed downstream of the forming station along the machine direction. The imaging device is configured to generate image data corresponding to a portion of the cementitious board as the cementitious board is conveyed past the imaging device. The imaging device has a field of view with a cross-machine view distance measured along the cross-machine direction. The cross-machine view distance of the imaging device is configured such that the image data includes edge data for both edges of the cementitious board.

The light assembly includes a light source and a fixture. The light source is mounted in the fixture. The fixture comprises a reflector in the form of a U-shaped channel with a base that is wide enough to allow the light source to be mounted thereto and a pair of sidewalls that are configured to focus the light emitted by the light source so that it is directionally projected onto the board. The fixture is arranged with the imaging device so that the light beam projected by the light source strikes the board within the field of view of the imaging device. In embodiments, the light assembly does not include any transparent optics or lenses separate from the light source.

In embodiments, the light assembly is positioned along the cross-machine direction so that focused light is emitted along the cross-machine direction over the entire width of the board, measured from edge to edge of the board along the cross-machine direction. The light assembly has an axial length, extending along the cross-machine direction, that is greater than a width of the cementitious board, measured along the cross-machine direction.

The non-transitory, computer-readable medium bears a defect detecting program. The processor is in operable arrangement with the imaging device to receive the image data and is in operable arrangement with the non-transitory, computer-readable medium to execute the defect detecting program contained thereon. The defect detecting program includes an image analysis module configured to analyze the image data to identify at least one defect condition of the cementitious board.

In one embodiment, a method of manufacturing a cementitious board includes conveying the cementitious board along a machine direction away from a forming station. The cementitious board has a pair of edges disposed in lateral spaced relationship to each other along a cross-machine direction, which is perpendicular to the machine direction. The edges of the cementitious board extend along the machine direction.

An imaging device is used to generate image data corresponding to the cementitious board as the cementitious board is conveyed past the imaging device. The imaging device is disposed downstream of the forming station along the machine direction. The imaging device has a field of view with a cross-machine view distance measured along the cross-machine direction. The cross-machine view distance of the imaging device is configured such that the image data includes both edges of the cementitious board.

A light source mounted in a fixture is operated to emit a light beam that strikes the board in the field of view of the imaging device. The fixture comprises a reflector in the form of a U-shaped channel with a base that is wide enough to allow the light source to be mounted thereto and a pair of sidewalls that are configured to focus the light emitted by the light source by reflecting at least a portion of the light beam so that it is directionally projected onto the board.

The image data are transmitted to a processor. A defect detecting program stored upon a non-transitory, computer-readable medium is executed using the processor to subject the digital image to defect detection analysis. The defect detection analysis includes identifying at least on defect condition of the board, such as a crack or surface defect, for example.

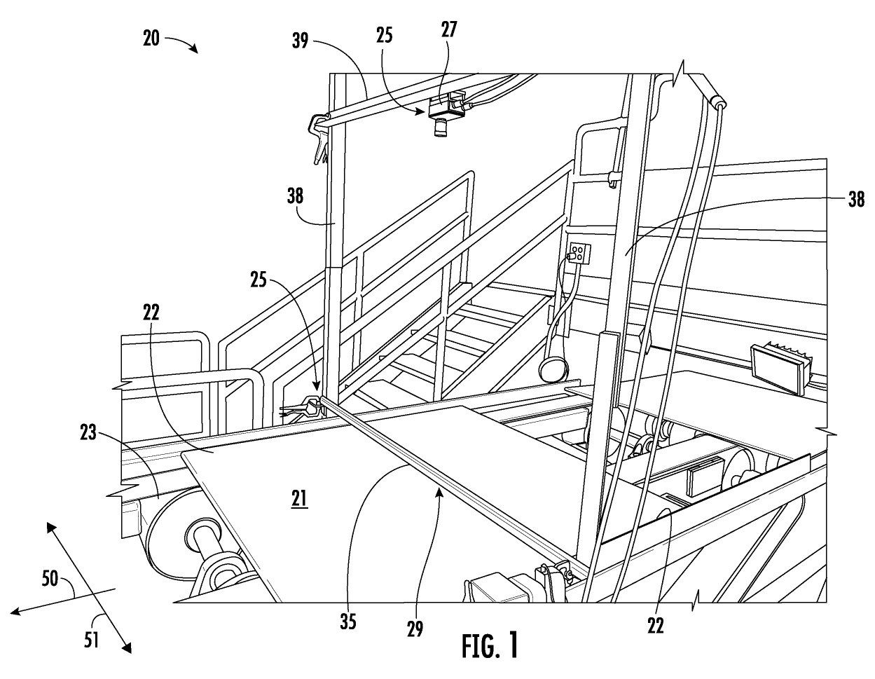

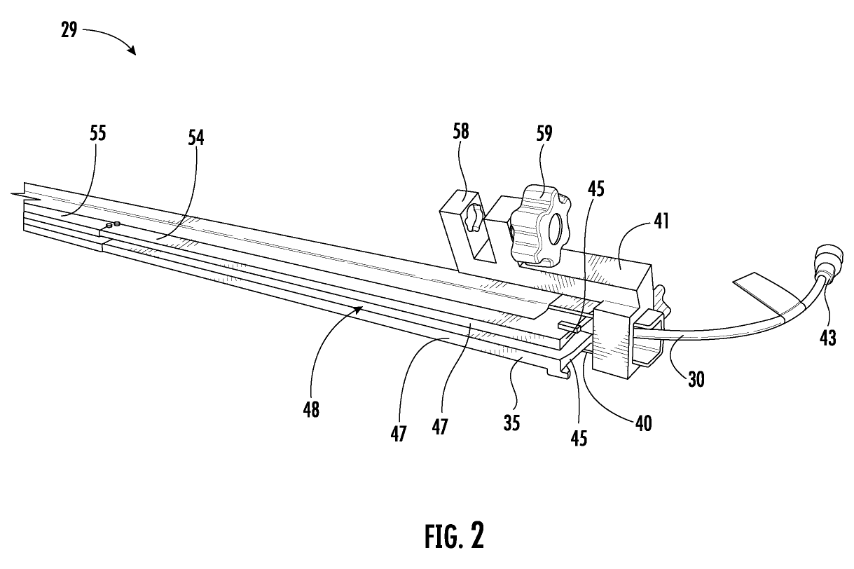

Turning now to the Figures, referring to FIG. 1, there is shown an embodiment of system 20 for manufacturing cementitious board 21 including a conveyor 23 for conveying the board 21 along a machine direction 50 and a defect detection system 25 for detecting a defect in the board 21 during continuous manufacture thereof which is constructed in accordance with principles of the present disclosure. The defect detection system 25 includes an imaging device 27 in the form of a camera/computer vision system, a light assembly 29 with a light source 30 and a fixture 35 for receiving the light source 30 therein and for focusing the light beam emitted by the light source 30 by reflecting at least a portion of the light beam (see also, FIG. 2), and a controller (not shown).

Referring to FIG. 1, the board 21 has a pair of edges 22 extending along the machine direction 50 and in lateral offset relationship with each other along a cross-machine direction 51 that is perpendicular to the machine direction 50. The conveyor 23 is configured to convey the board 21 along the machine direction 50 such that the edges 22 of the board 21 extend along the machine direction 50.

The imaging device 27 is arranged with the conveyor 23 to capture image data of the board 21 being produced at that time and being conveyed along the machine direction 50 by the conveyor 23. The imaging device 27 is configured to generate image data corresponding to a portion of the cementitious board 21 as the cementitious board 21 is conveyed past the imaging device 27.

In the illustrated embodiment, a pair of vertical uprights 38 project upwardly from the conveyor 23 on either side thereof. The imaging device 27 is mounted from a cross bar 39 extending between the vertical uprights 38 at a central location along the cross-machine direction 51 at a height above the board 21 sufficient to allow the field of view of the imaging device to have a cross-machine view distance, measured along the cross-machine direction 51, sufficient to generate image data that includes edge data for both edges 22 of the board 21.

In embodiments, the imaging device 27 can comprise any suitable camera/computer vision system, such as, e.g., a line scan camera. In embodiments, the fixture 35 is configured such that the light beam projected onto the board 21 covers the field of view of the line scan camera. In embodiments, any suitable commercially-available camera/computer vision system can be used, such as those available from Limab AB of Sweden.

The light source 30 is mounted in the fixture 35 (see also, FIG. 2). The fixture 35 is configured to mechanically house the light source 30 and to focus the light emitted by the light source 30 by reflecting at least a portion of the light beam so that it is directionally projected onto the board 21 to enhance defect visibility in the image taken by the camera/computer vision system 27. The light assembly 29 is positioned along the cross-machine direction 51 so that focused light is emitted along the cross-machine direction 51 over the entire width of the board 21, measured from edge to edge of the board 21 along the cross-machine direction 51.

In the illustrated embodiment, the fixture 35 is arranged with the imaging device 27 so that the light beam projected by the light source 30 strikes the board 21 within the field of view of the imaging device 27. The fixture 35 is mounted to the vertical uprights 38 at a height above the board 21 sufficient to allow the light beam to strike the board 21 within the field of view of the imaging device 27. The fixture 35 is offset slightly from the imaging device 27 along the machine direction 50 so that the imaging device 27 can have an unobstructed field of view of the board 21 as it passes by along the conveyor 23. In embodiments, the fixture 35 can be pivotably mounted with respect to its longitudinal axis so that the incident angle of the light beam striking the board 21 can be varied.

Referring to FIG. 2, in embodiments, the light assembly 29 can include the light source 30, the fixture 35, a mounting base 40 within which the fixture 35 is secured, and at least one mounting clamp 41 positioned at each end of the light assembly 29. The light source 30 includes a power cord 43 extending from the fixture 35 for ready connection to a suitable power source, such as a suitable low-voltage power source, such as, e.g., 12VDC or 24VDC. The light source 30 extends along the length of the fixture 35. The illustrated light source 30 comprises a COB LED light strip with an adhesive backing that is used to mount the light source 30 to the bottom of the fixture 35.

In embodiments, the light source 30 can comprise any suitable light source which emits a relatively uniform light beam that can help illuminate the board 21 so that the imaging device 27 can generate an image suitable for defect detection. In embodiments, the light emitted by the fixtured light source 30 enhances the image generated by the imaging device 27 to allow the controller with which it is operably arranged to detect a defect condition present in the image. In embodiments, the light source 30 comprises a suitable COB LED light strip. For example, in embodiments, the light source 30 can comprise a COB LED strip light that is a 8mm width strip of 480 white LEDs/meter of length to produce a light with suitable density and uniformity.

The fixture 35 comprises a U-shaped channel with a pair of sidewalls 45. The light source 30 is mounted within the U-shaped channel. The sidewalls 45 each have a distal end 47 cooperating together to define an open outlet 48 through which the light beam emitted by the light source 30 mounted to the base of the fixture 35 can pass. In embodiments, the sidewalls 45 can be made from a material that is reflective or have a reflective coating or layer applied thereto.

In embodiments, the axial length of the fixture 35 is greater than the edge-to-edge width of the board under inspection so that lighting is provided laterally up to and beyond the width of the board 21. In embodiments, the fixture 35 can be composed of a plurality of segments 54, 55 that are joined together via a suitable technique so that the overall axial length of the fixture 35 is sufficient to span from edge-to-edge of the board 21 under inspection. In the illustrated embodiment, the fixture segment 54, 55 includes an angled pin at one end and a complementary angled socket at the other end. A pin of one fixture segment 54 can be inserted into a socket of another fixture segment 55 to join fixture segments 54, 55 together.

The mounting base 40 can be made from any suitable material and can be configured to support the fixture 35 when mounted with respect to the conveyor 23. In the illustrated embodiment, the mounting base 40 comprises a metal channel configured to receive therein the connecting web base of the fixture 35. The fixture 35 can be secured to the mounting base 40 via any suitable technique, such as adhesive or fasteners.

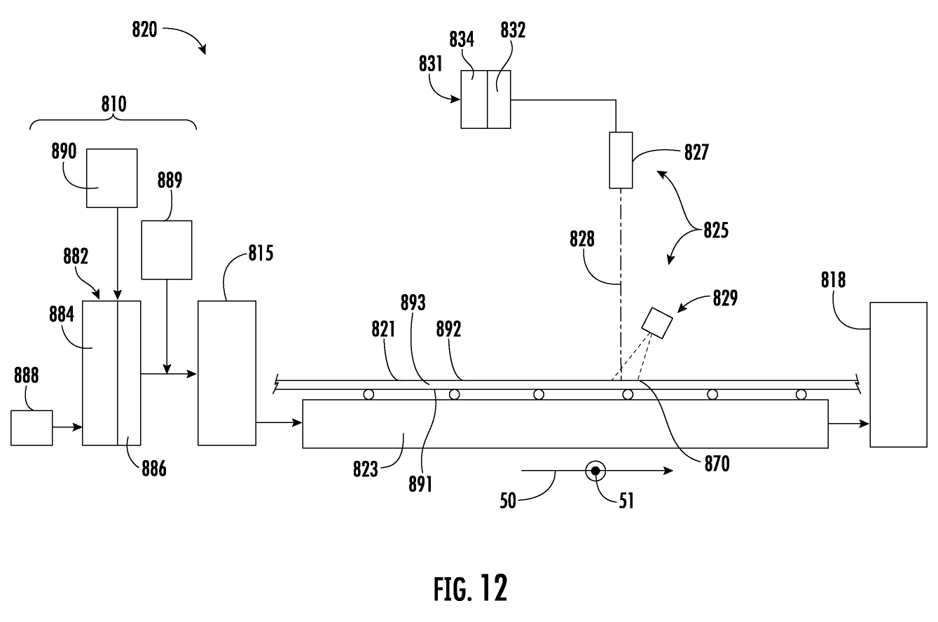

In embodiments, each mounting clamp 41 can be configured to secure the fixture 35 with respect to the conveyor 23. The mounting clamp 41 can be configured to secure the light assembly 29 to the vertical uprights 38 shown in FIG. 1. In the illustrated embodiment, the mounting clamp 41 includes jaws 58 and a threaded wheel 59 which be rotated to advance or retract a threaded rod for use in securing a structure member, such as the vertical upright 38 of FIG. 1, between the jaws 58. In embodiments, the jaws 58 can be configured to mount the fixture 35 at a predetermined orientation relative to a normal, vertical axis such that the light beam emitted by the light source 30 is at a non-perpendicular incident angle relative to the face surface of the board 21 (see, e.g., FIG. 12). In embodiments, the fixture 35 can be mounted at any suitable angle relative to the board such that the incident angle of the light beam striking the board 21 can be varied. For example, in embodiments, the light beam emitted by the light source 30 is at an incident angle of about twenty degrees relative to the face surface of the board. In embodiments, the mounting clamp 41 can be adjustable to change the incident angle of the light beam striking the surface of the board 21.

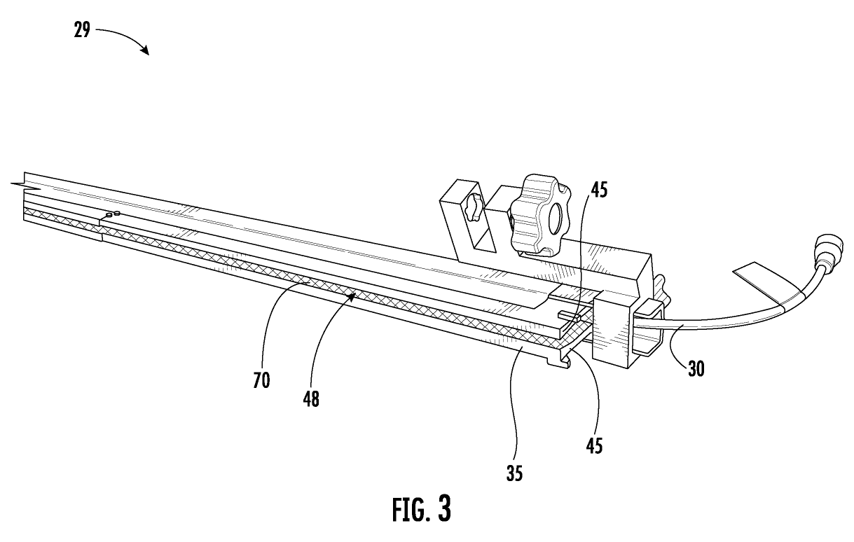

Referring to FIG. 3, in embodiments, the fixture 35 can be configured such that a light beam 70 emitted from the fixture 35 is focused relative to the light beam spread that the light source 30 mounted therein would emit when it is not disposed within the fixture 35. In embodiments, the open outlet 48 of the fixture 35 through which the light beam emitted by the light source 30 passes can be configured such that the light beam is focused. In embodiments, the outlet 48 and/or sidewalls 45 of the fixture 35 can have a different configuration to change the focused light beam emitted from the fixture 35.

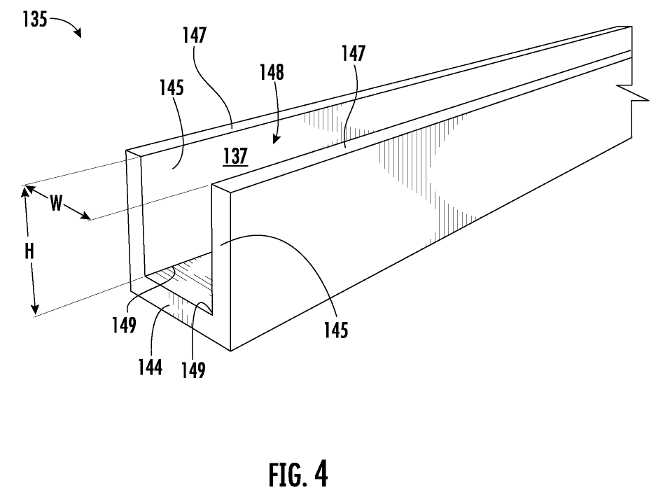

Referring to FIG. 4, an embodiment of a light fixture 135 is shown that is suitable for use in a light assembly of a defect detection system constructed in accordance with principles of the present disclosure. The illustrated light fixture 135 comprises a reflector in the form of a U-shaped channel that includes a connecting web base 144 and a pair of sidewalls 145 respectively projecting from an end 149 of the base 144. The sidewalls 145 define an open outlet 148 at their distal ends 147 through which the light beam emitted by a light source mounted to the base 144 of the fixture 135 can pass.

The base 144 can be configured to permit the light source to be mounted thereto using any suitable technique, such as, e.g., by adhesive or fasteners. The base 144 of the illustrated fixture 135 has an internal width W that is wide enough to allow a light source having an 8mm width to be mounted thereto. In embodiments, the width W of the base 144 can be adjusted to accommodate light sources of different widths therein.

Each sidewall 145 includes an internal reflective surface 137 for reflecting at least a portion of the light beam emitted by the light source. Each reflective surface 137 is configured to help focus the light beam emitted from the open outlet 148. The reflective surfaces 137 of the fixture 135 shown in FIG. 4 are substantially planar.

The sidewalls 145 are configured to focus the light emitted by the light source mounted to the fixture 135 by reflecting at least a portion of the light beam so that it is directionally projected out of the open outlet 148 onto the board. In the illustrated embodiment, the sidewalls 145 are generally planar flanges that extend perpendicularly from the base 144. In other embodiments, the sidewalls 145 can project in a tapered fashion from the base 144. In the illustrated embodiment, the internal reflective surface 137 of the sidewalls 145 project from the base 144 such that they have a height H of 10mm. In other embodiments, the sidewalls 145 can have a different height to vary the degree to which the light beam emitted from the light source is focused.

In embodiments, a ratio of the height H of the internal reflective surface 137 of the sidewalls 145 to the width W of the base 144 is greater than 1. In the illustrated embodiment, the ratio of the height H of the internal reflective surface 137 of the sidewalls 145 to the width W of the base 144 is 1.22. In embodiments, a ratio of the height H of the internal reflective surface 137 of the sidewalls 145 to the width W of the base 144 is in a range from 1 to 7, a range from 1 to 6 in other embodiments, a range from 1 to 5 in yet other embodiments, and a range from 1 to 4 in still other embodiments.

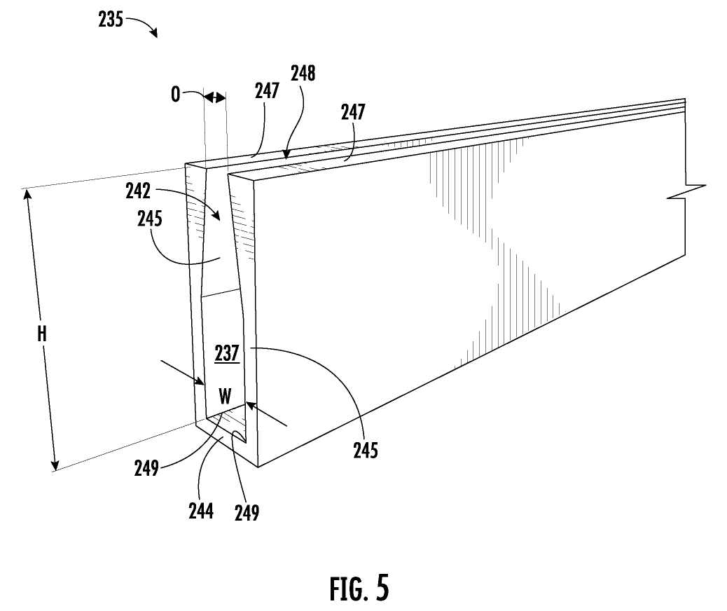

Referring to FIG. 5, another embodiment of a light fixture 235 is shown that is suitable for use in a light assembly of a defect detection system constructed in accordance with principles of the present disclosure. The illustrated light fixture 235 of FIG. 5 comprises a reflector in the form of a U-shaped channel that includes a connecting web base 244 and a pair of sidewalls 245 respectively projecting from an end 249 of the base 244. The sidewalls 245 include tapered distal ends 247 that define an open outlet 248 through which the light beam emitted by a light source mounted to the base 244 of the fixture 235 can pass. The open outlet 248 of the fixture 235 of FIG. 5 has an outlet width O which is narrower than the outlet width of the open outlet of the light fixture 135 of FIG. 4. The outlet width O of the open outlet 248 of the fixture 235 of FIG. 5 is less than a width W of the base 244.

Each sidewall 245 includes an internal reflective surface 237 for reflecting at least a portion of the light beam emitted by the light source. Each reflective surface 237 is configured to help focus the light beam emitted from the open outlet 248. Each reflective surface 237 incudes a distal tapered surface 242 that converges toward the other sidewall 245. The rest of the reflective surfaces 237 of the fixture 235 shown in FIG. 5 are substantially planar. In embodiments, the sidewalls 245 can be planar and tapered inwardly from the ends 249 of the base 244 to define an open outlet with an outlet width O that is narrower than the internal width W of the base 244.

In embodiments, a ratio of the outlet width O of the sidewalls 245 to the width W of the base 244 is less than 1. In embodiments, a ratio of the outlet width O of the sidewalls 245 to the width W of the base 244 is less than 1. In the illustrated embodiment, the ratio of the outlet width O of the sidewalls 245 to the width W of the base 244 is 0.49. In embodiments, the ratio of the outlet width O of the sidewalls 245 to the width W of the base 244 is in a range from 0.25 to 1, a range from 0.3 to 1 in other embodiments, a range from 0.35 to 1 in still other embodiments, and a range from 0.4 to 1 in still other embodiments.

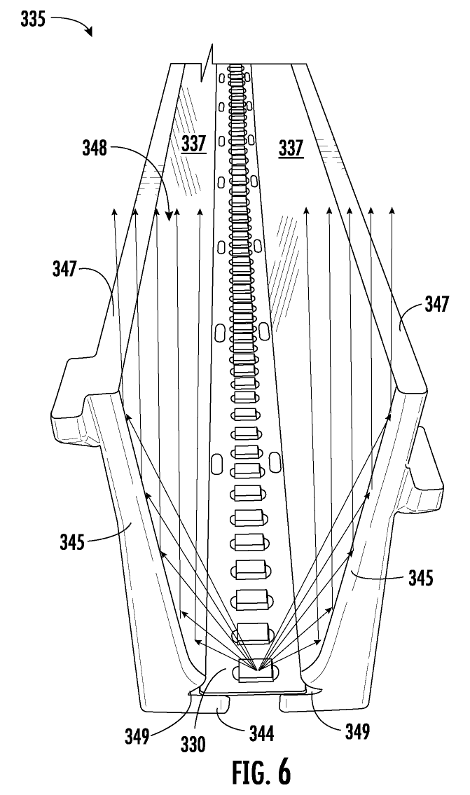

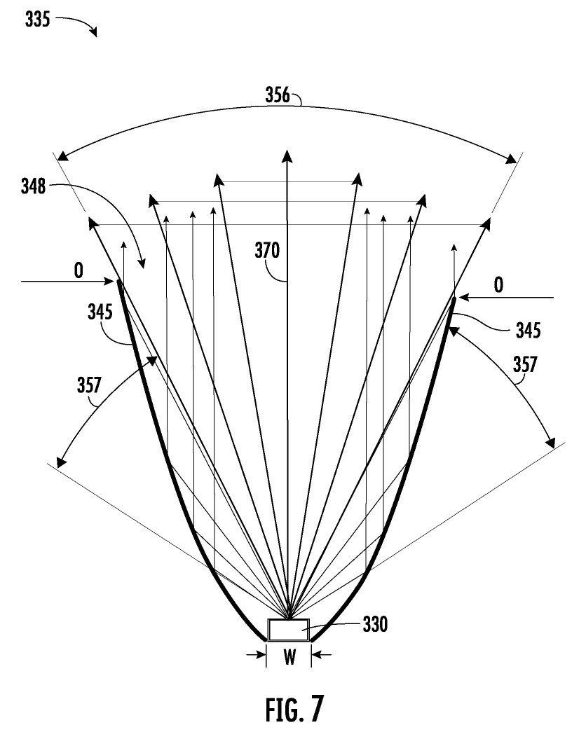

Referring to FIGS. 6 and 7, another embodiment of a light fixture 335 is shown that is suitable for use in a light assembly of a defect detection system constructed in accordance with principles of the present disclosure. The illustrated light fixture 335 of FIGS. 6 and 7 comprises a reflector in the form of a U-shaped channel that includes a connecting web base 344 and a pair of sidewalls 345 respectively projecting from an end 349 of the base 344. The sidewalls 345 are parabolic-shaped and define an open outlet 348 through which the light beam emitted by the light source 330 mounted to the base 344 of the fixture 345 can pass. The two parabolic-shaped sidewalls 345 can be positioned according to the focal point of the LED light strip 330 mounted therein such that light from the outer portions of the LEDs beam spread are reflected from the parabolic-shaped sidewalls 345 and projected out of the open outlet 348 upon the board under inspection. The open outlet 348 of the fixture of FIGS. 6 and 7 has an outlet width O which is greater than the width W of the base 344.

Each sidewall 345 includes an internal reflective surface 337 for reflecting at least a portion of the light beam emitted by the light source. Each reflective surface 337 is configured to help focus the light beam emitted from the open outlet 348. Each reflective surface 337 has a parabolic curved-shape. In embodiments, the internal reflective surface 337 of the sidewalls 345 can be defined by a suitable parabolic formula. In embodiments, the internal reflective surface 337 of the sidewalls 345 can be configured to have a parabolic shape such that light emitted from the light source, which is positioned substantially at the focus of the parabola at the focus, is reflected into a parallel (or collimated) beam relative to the axis of symmetry defined between the reflective surfaces 337 of the fixture 335. In embodiments, the sidewalls 345 can have another curved shape suitable for helping to reflect the light beam spread emitted from the light source 330.

Referring to FIG. 7, the fixture 335 is configured such that a light beam 370 emitted from the fixture 335 is focused relative to the light beam spread that the light source 330 mounted therein would emit when it is not disposed within the fixture 335. The light beam 370 includes a central portion 356 of the light beam spread emitted from the light source 330 which does not interact with the reflector 335 and a pair of lateral portions 357 of the light beam spread that reflect from the parabolic-shaped sidewalls 345 of the fixture 335. In embodiments, the sum of the lateral portions 357 is about equal to the central portion 356. In embodiments, the sum of the lateral portions 357 is greater than the central portion 356. In embodiments, the lateral portion 357 is in a range between ten degrees and fifty degrees.

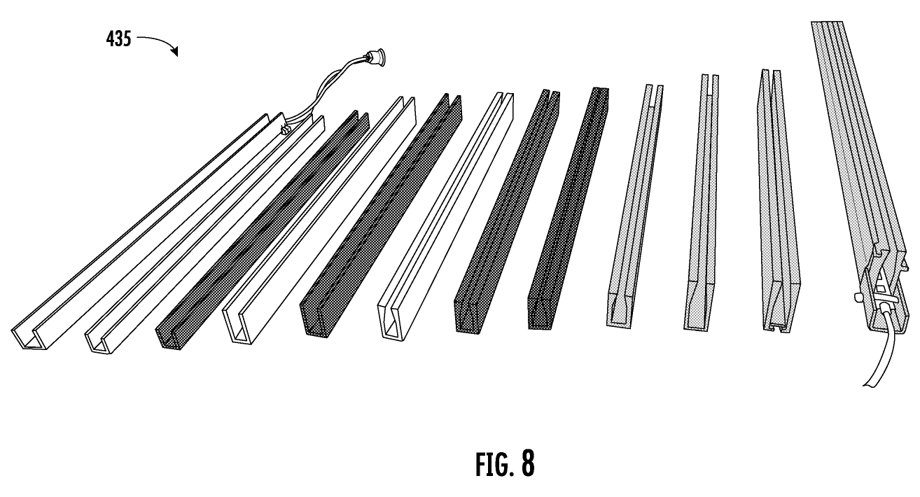

Referring to FIG. 8, other embodiments of a light fixture 435 are shown that are suitable for use in a light assembly of a defect detection system constructed in accordance with principles of the present disclosure, illustrating light fixtures with different suitable base and sidewall dimensions and made from different materials. In embodiments, the light fixture can be constructed form any suitable material, such as a suitable plastic, and can be made by any suitable technique, such as by additive manufacturing (also called, e.g., 3D printing) using silk silver plastic for mirror-like reflectivity. In embodiments, the light fixture can be constructed form any suitable reflective material, such as plastic, metal, or reflective-coated or reflective-lined materials. In the embodiments shown in FIG. 8, plastic materials with different colors were used to construct the light fixtures using additive manufacturing, namely white plastic, black plastic, silver plastic, and silver silk plastic. In other embodiments, different plastic colors can be used. In yet other embodiments, the light fixture can be made from a suitable metal, such as, e.g., aluminum or steel.

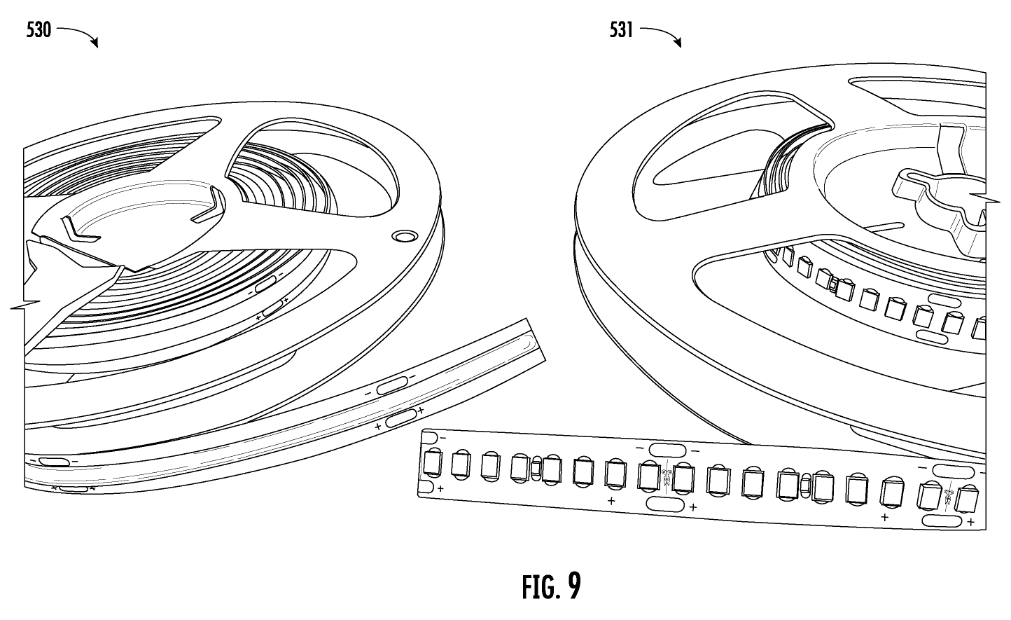

Referring to FIG. 9, in embodiments the light source 530, 531 can comprise any suitable LED light strip in a defect detection system constructed according to principles of the present disclosure. For example, the light source can comprise a suitable COB LED light strip 530 or a suitable SMD LED light strip 531, as shown in FIG. 9, for example. In embodiments, the LED light strips 530, 531 can be trimmed to a desired axial length and mounted within the light fixture using a suitable technique as will be appreciated by one skilled in the art so that the trimmed LED light strip extends along the light fixture a predetermined length.

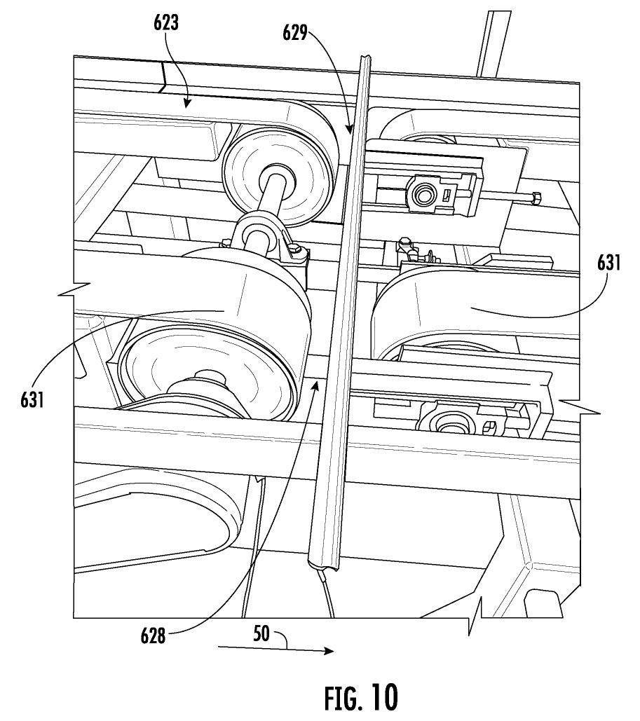

Referring to FIG. 10, in embodiments, the light assembly 629 can be located at any suitable location with respect to the conveyor 623. In embodiments, the imaging device (not shown) and the light assembly 629 can be mounted within the conveyor 623 and positioned so that the field of view of the imaging device includes the cover sheet of the board in contact with the conveyor 623 (typically the face of the board) for monitoring the occurrence of defects showing on the face of the board. In the illustrated embodiment, the light assembly 629 is located along the machine direction 50 such that the light assembly 629 is disposed in a gap 628 between conveyor belt segments 631. This location can help remove features of the conveyor 623 from the background of the image taken by the imaging device.

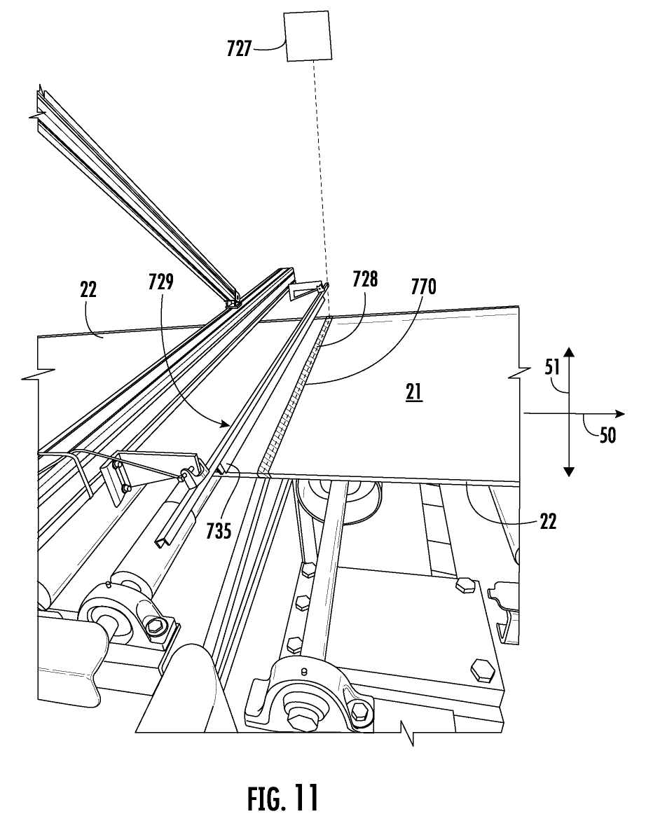

Referring to FIG. 11, the imaging device 727 has a field of view 728 with a cross-machine view distance measured along the cross-machine direction 51. The cross-machine view distance of the imaging device 727 is configured such that the image data includes edge data for both edges 22 of the cementitious board 21. The light assembly 729 has an axial length extending along the cross-machine direction 51 such that the axial length of the light assembly 729 is greater than a width of the cementitious board 21 measured along the cross-machine direction 51. Accordingly, the axial length of the light assembly 729 is greater than the edge-to-edge width of the board 21 under inspection so that lighting is provided laterally up to and beyond the width of the board.

In the illustrated embodiment, the imaging device 727 comprises a line scan camera. The fixture 735 is configured such that the light beam 770 projected from the light assembly 729 onto the board 21 covers the field of view 728 of the line scan camera.

Referring to FIG. 12, in embodiments of a system 820 for manufacturing a cementitious board 821 constructed according to principles of the present disclosure, the system 820 can include a wet end system 810, a forming station 815, a conveyor 823, a defect detection system 825 constructed according to principles of the present disclosure, and a cutting station 818. The defect detection system 825 includes an imaging device 827, a light assembly 829, and a controller 831 with a processor 832 in operable arrangement with a non-transitory, computer-readable medium 834 bearing a defect detecting program.

The wet end system 810 and the forming station 815 are configured to mix and assemble constituent materials together such that a continuous cementitious board 821 having a predetermined nominal thickness is fed from the forming station 815 along the conveyor 82 in a machine direction 50 toward the cutting station 818.

The cementitious board 821 has a pair of edges extending along the machine direction 50. The edges are disposed in lateral spaced relationship to each other along a cross-machine direction 51 which is perpendicular to the machine direction 50.

In embodiments, the board 821 includes at least one facer. In embodiments, the cementitious board 821 has a cementitious core interposed between a pair of cover sheets.

In embodiments, the imaging device 827 is in the form of a camera. The cementitious board 821 can be conveyed by the conveyor 823 underneath the imaging device 827 such that image data corresponding to the cementitious board 821 passing by along the conveyor 823 can be acquired by the imaging device 827 and transmitted to the processor 832 of the controller 831. The processor 832 is configured to execute the defect detecting program stored upon the non-transitory, computer-readable medium 834 to evaluate the image data generated by the imaging device 827 in order to determine whether a defect condition exists within the cementitious board 821.

The light assembly 829 is configured to direct a focused light beam 870 onto the board 821 to facilitate the capture of image data by the imaging device 827 suitable for evaluation by the controller 831. The light source mounted in the fixture of the light assembly 829 can be operated to emit a light beam that strikes the board 821 within the field of view 828 of the imaging device 827. The fixture reflects at least a portion of the light beam emitted by the light source. In embodiments, the imaging device 827 comprises a line scan camera, and the fixture of the light assembly 829 is configured such that the light beam 870 that strikes the board 821 covers the field of view 828 of the line scan camera 827. In embodiments, any suitable light assembly 829 constructed according to principle of the present disclosure can be used.

The wet end system 810 can include any suitable equipment adapted to mix and/or assemble the constituent materials forming the cementitious board 821. In embodiments, the wet end system 810 is configured as a gypsum wallboard wet end system.

In embodiments, the wet end system 810 includes a cementitious slurry mixing and dispensing system 882 having a slurry mixer 884 in fluid communication with a slurry dispensing system 886. The slurry mixer 884 is adapted to agitate water and a cementitious material (such as, calcined gypsum, for example) to form aqueous cementitious slurry. Both the water and the cementitious material can be supplied to the mixer 884 via one or more inlets as is known in the art. In embodiments, any other suitable slurry additive can be supplied to the mixer 884 as is known in the art of manufacturing cementitious products, such as, for example, fiber. Any suitable mixer (e.g., a pin mixer as is known in the art and commercially available from a variety of sources) can be used.

In use, water and a cementitious material, such as calcined gypsum, for example, can be agitated in the mixer 884 to form aqueous cementitious slurry. In some embodiments, water and calcined gypsum can be continuously added to the mixer 884 in a water-to-calcined gypsum ratio from about 0.5 to about 1.3, and in other embodiments of about 0.75 or less.

The slurry dispensing system 886 is in fluid communication with the slurry mixer 884 and is configured to dispense a main flow of cementitious slurry from the slurry mixer 884 upon a forming table extending between the cementitious slurry mixing and dispensing system 882 and the forming station 815. In embodiments, the slurry dispensing system 886 can include a suitable discharge conduit, as is known in the art. The discharge conduit can be made from any suitable material and can have different shapes. In some embodiments, the discharge conduit can comprise a flexible conduit. Cementitious slurry can be discharged from the slurry dispensing system 886 in an outlet flow direction substantially along the machine direction 50.

One or more flow-modifying elements can be associated with the discharge conduit and adapted to modify the flow of aqueous cementitious slurry from the slurry mixer 884 through the discharge conduit 886. The flow-modifying element(s) can be used to control an operating characteristic of the flow of aqueous cementitious slurry. Examples of suitable flow-modifying elements include volume restrictors, pressure reducers, constrictor valves, canisters, etc., including those described in U.S. Patent Nos. 6,494,609; 6,874,930; 7,007,914; and 7,296,919, for example.

It is further contemplated that other discharge conduits, including other discharge conduits with different slurry distributors or boots, can be used in other embodiments of a cementitious slurry mixing and dispensing system 882. For example, in other embodiments, the discharge conduit can include at its terminal end a slurry distributor similar to one of those shown and described in U.S. Patent Application Nos. 2012/0168527; 2012/0170403; 2013/0098268; 2013/0099027; 2013/0099418; 2013/0100759; 2013/0216717; 2013/0233880; and 2013/0308411, for example. In some of such embodiments, the discharge conduit 886 can include suitable components for splitting a main flow of cementitious slurry into two flows which are re-combined in the slurry distributor.

A first roll 888 of cover sheet material can be configured to be selectively dispensed such that the first cover sheet 891 is dispensed from the first roll 888 upstream of the slurry dispensing system 886 upon the forming table extending between the slurry mixer and dispensing system 882 and the forming station 815. In embodiments, a second roll 889 of cover sheet material can be configured to be selectively dispensed such that the second cover sheet 892 is dispensed from the second roll 889 upon the forming table at a position between the slurry dispensing system 886 of the cementitious slurry mixing and dispensing system 882 and the forming station 815 over the first cover sheet 891 and the slurry dispensed from the slurry dispensing system 886. Gypsum board products are typically formed “face down” such that the first cover sheet 891 dispensed from the first roll 888 traveling over the forming table serves as the “face” cover sheet of the finished cementitious board 821.

In embodiments, a foam injection system 890 can be arranged with at least one of the mixer 884 and the slurry dispensing system 886. The foam injection system 890 can include a foam source (e.g., such as a foam generation system configured as known in the art) and a foam supply conduit.

In embodiments, any suitable foam source can be used. Preferably, the aqueous foam is produced in a continuous manner in which a stream of a mix of foaming agent and water is directed to a foam generator, and a stream of the resultant aqueous foam leaves the generator and is directed to and mixed with the cementitious slurry. In embodiments, any suitable foaming agent can be used. Preferably, the aqueous foam is produced in a continuous manner in which a stream of the mix of foaming agent and water is directed to a foam generator, and a stream of the resultant aqueous foam leaves the generator and is directed to and mixed with the slurry. Some examples of suitable foaming agents are described in U.S. Patent Nos. 5,683,635 and 5,643,510, for example.

The aqueous foam supply conduit can be in fluid communication with at least one of the slurry mixer 884 and the slurry dispensing system 886. An aqueous foam from a source can be added to the constituent materials through the foam supply conduit at any suitable location downstream of the mixer 884 and/or in the mixer 884 itself to form a foamed cementitious slurry. In embodiments, the foam supply conduit is disposed downstream of the slurry mixer 884 and is associated with a main delivery trunk of the discharge conduit 886. In some embodiments, the aqueous foam supply conduit has a manifold-type arrangement for supplying foam to a plurality of foam injection ports defined within an injection ring or block disposed at a terminal end of the foam supply conduit and associated with the discharge conduit 886, as described in U.S. Patent No. 6,874,930, for example. In embodiments, a flow-modifying element is disposed downstream of the foam injection body and the aqueous foam supply conduit relative to a flow direction of the flow of cementitious slurry from the mixer 884 through the discharge conduit 886.

In other embodiments, one or more foam supply conduits can be provided in fluid communication with the mixer 884. In yet other embodiments, the aqueous foam supply conduit(s) can be in fluid communication with the slurry mixer 884 alone. As will be appreciated by those skilled in the art, the means for introducing aqueous foam into the cementitious slurry in the cementitious slurry mixing and dispensing system 882, including its relative location in the system, can be varied and/or optimized to provide a uniform dispersion of aqueous foam in the cementitious slurry to produce board that is fit for its intended purpose.

In embodiments in which the cementitious slurry comprises gypsum slurry, one or both of the cover sheets 891, 892 can be pre-treated with a very thin relatively denser layer of gypsum slurry (relative to the gypsum slurry comprising the core), often referred to as a “skim coat” in the art, and/or hard edges, if desired. To that end, in embodiments, the mixer 84 can include a first auxiliary conduit that is adapted to deposit a stream of dense aqueous cementitious slurry that is relatively denser than the main flow of aqueous calcined gypsum slurry delivered to the discharge conduit (i.e., a “face skim coat/hard edge stream”).

In embodiments, a hard edge/face skim coat roller is disposed upstream of the slurry dispensing system 886 of the cementitious slurry mixing and dispensing system 882 and supported over the forming table such that the first cover sheet 891 being dispensed from the first roll 888 is disposed therebetween. The first auxiliary conduit can deposit the face skim coat/hard edge stream upon the first cover sheet 891 being dispensed from the first roll 888 upstream of the skim coat roller which is adapted to apply a skim coat layer to the moving first cover sheet 891 and to define hard edges at the periphery of the moving first cover sheet 891 by virtue of the width of the roller being less than the width of the moving first cover sheet 891 as is known in the art. Hard edges can be formed from the same dense slurry that forms the thin dense layer by directing portions of the dense slurry around the ends of the roller used to apply the dense layer to the first cover sheet 891.

In some embodiments, a back skim coat roller is disposed over a support element such that the second cover sheet 892 being dispensed from the second roll 889 is disposed therebetween. The mixer 884 can also include a second auxiliary conduit adapted to deposit a stream of dense aqueous calcined gypsum slurry that is relatively denser than the main flow of aqueous calcined gypsum slurry delivered to the discharge conduit (i.e., a “back skim coat stream”). The second auxiliary conduit can deposit the back skim coat stream upon the moving second cover sheet 892 upstream (in the direction of movement of the second cover sheet 892) of the back skim coat roller that is adapted to apply a skim coat layer to the second cover sheet 892 being dispensed from the second roll 889 as is known in the art.

In other embodiments, separate auxiliary conduits can be connected to the mixer 884 to deliver one or more separate edge streams to the moving cover sheet 891. Other suitable equipment (such as auxiliary mixers) can be provided in the auxiliary conduits to help make the slurry therein denser, such as by mechanically breaking up foam in the slurry and/or by chemically breaking down the foam through use of a suitable de-foaming agent.

The skim coat rollers, the forming table, and the support element can all comprise equipment suitable for their respective intended purposes as is known in the art. The wet end system 810 can be equipped with other suitable equipment as is known in the art.

In use, the first cover sheet 891 is dispensed from the first roll 888 and moves along the machine direction 50. The cementitious slurry is discharged from the discharge conduit 886 upon the moving first cover sheet 891. The face skim coat/hard edge stream can be deposited from the mixer 884 at a point upstream of where the cementitious slurry is discharged from the discharge conduit 886 upon the moving first cover sheet 891 relative to the direction of movement of the first cover sheet 891 in the machine direction 50. A back skim coat stream (a layer of denser slurry relative to the main flow of cementitious slurry being discharged from the discharge conduit) can be applied to the second cover sheet 892 being dispensed from the second roll 889. The back skim coat stream can be deposited from the mixer 884 at a point upstream of the back skim coat roller relative to the direction of movement of the moving second cover sheet 892. In embodiments, aqueous foam or other agents can be added to the slurry comprising the face skim coat and/or back skim coat to reduce its density, but at a density that is greater than the foamed slurry dispensed from the discharge conduit.

The moving second cover sheet 892 can be placed upon the slurry deposited upon the advancing first cover sheet 891 to form a sandwiched wallboard preform that is fed to the forming station 815 to shape the preform to a desired thickness. The cementitious board 821 has a cementitious core 893 interposed between the cover sheets 891, 892.

The forming station 815 is configured to form the cementitious board 821 such that the cementitious board is within a predetermined thickness range. The forming station 815 can comprise any equipment suitable for its intended purpose as is known in the art.

The conveyor 823 is configured to convey the cementitious board 821 along the machine direction 50 away from the forming station 815 such that the edges of the cementitious board 821 extend along the machine direction 50. In embodiments, the conveyor 823 is configured such that it has a length, measured along the machine direction 50, sufficient to allow the cementitious slurry constituting the cementitious core 893 to adequately set before reaching the cutting station 818 such that the cementitious board 821 can be cut.

In embodiments, the imaging device 827 can be any suitable device configured to generate image data corresponding to the cementitious board 821. The illustrated imaging device 827 is disposed downstream of the forming station 815 along the machine direction 50 and, in embodiments, can be disposed either upstream or downstream of the cutting station 818. In the illustrated embodiment, the imaging device 827 is disposed upstream of the cutting station 818. In embodiments, the imaging device 827 is disposed downstream of a kiln. The imaging device 827 can be configured to generate image data corresponding to the portion of the cementitious board 821 within the field of view 828 of the imaging device 827 as the cementitious board 821 is conveyed from the forming station 815 along the machine direction 50 past the imaging device 827.

The imaging device 827 is in operable arrangement with the controller 831. The imaging device 827 can be configured to selectively operate, in response to receiving command signals from the controller 831, to generate image data. The imaging device 827 can be configured to transmit the image data to the processor 832 of the controller 831. The processor 832 of the controller 831 can use the image data, for example, to perform defect detection analysis (e.g., determining whether a crack, blowout, peeler, or other surface defect is present) and/or to display an image of the cementitious board 821 on a display device such as a video monitor.

In embodiments, the imaging device 827 is in the form of a camera which is configured to produce a digital image of the cementitious board 821 as it travels past the camera. In embodiments, the imaging device 827 can be a suitable, commercially-available camera.

In embodiments, the camera 827 can also include a display for a user to view images generated by the camera 827. The camera 827 can be configured to generate a suitable digital image of the cementitious board 821 disposed within the field of view 828. In embodiments, the image data can be stored in a storage device of the camera 827 and/or transmitted (e.g., via a wireless or wired network) to the processor 832 for remote viewing and/or storage.

The field of view 828 of the imaging device 827 has a cross-machine view distance, which is measured along the cross-machine direction 51. The portion of the cementitious board 821 within the field of view 828 has a cross-machine board distance, also measured along the cross-machine direction 51. The imaging device 827 is positioned relative to the cementitious board 821 and the field of view 828 of the imaging device 827 is configured such that the cross-machine view distance of the field of view 828 is greater than the cross-machine board distance of the portion of the cementitious board 821 within the field of view 828 such that the image data generated by the imaging device 827 includes both edges of the board 821 therein. In other words, the field of view 828 of the imaging device 827 is configured such that image data is obtained over the entire width, measured along the cross-machine direction 51, of the cementitious board 821 being analyzed by the imaging device 827.

The light assembly 829 is operated to direct a focused light beam 870 onto the board 821 to facilitate the capture of image data by the imaging device 827. The light source mounted in the fixture of the light assembly 829 can be operated to emit a light beam that strikes the board 821 within the field of view 828 of the imaging device 827. The fixture reflects at least a portion of the light beam emitted by the light source. In embodiments, the fixture of the light assembly 829 is configured such that the light beam 870 that strikes the board 821 is within the field of view 828 of the imaging device 827.

The controller 831 is in operable arrangement with the imaging device 827. In embodiments, the controller 831 is configured to selectively operate the imaging device 827 to generate image data corresponding to the cementitious board 821 as the cementitious board 821 passes by the imaging device 827.

In embodiments, the controller 831 can include a user input and/or interface device having one or more user actuated mechanisms (e.g., one or more push buttons, slide bars, rotatable knobs, a keyboard, and a mouse) adapted to generate one or more user actuated input control signals. In embodiments, the controller 831 can be configured to include one or more other user-activated mechanisms to provide various other control functions for the imaging device 827, such as, auto-focus, field of view adjustment, brightness, contrast, and/or various other features and/or parameters as will be appreciated by one skilled in the art. The controller 831 can include a display device adapted to display a graphical user interface. The graphical user interface can be configured to function as both a user input device and a display device in embodiments. In embodiments, the display device can comprise a touch screen device adapted to receive input signals from a user touching different parts of the display screen. In embodiments, the controller 831 can be in the form of a smart phone, a tablet, a personal digital assistant (e.g., a wireless, mobile device), a laptop computer, a desktop computer, or other type of device.

The processor 832 of the controller 831 is in operable arrangement with the imaging device 827 to receive the image data and is in operable arrangement with the non-transitory, computer-readable medium 834 to execute the defect detecting program contained thereon. The defect detecting program includes a defect analysis module configured to analyze the image data to identify whether a defect condition is present.

The processor 832 is operably arranged with the imaging device 827 to receive digital image information from the imaging device 827. The processor 832 is configured to manipulate the image information received from the imaging device, to convert that information into an image which can be stored in a data storage device operably arranged with the processor 832, and to transmit the image data to the defect detecting program 834 to analyze the cementitious board 821 for at least one defect condition, such as a crack, for example.

In embodiments, the processor 832 can comprise any suitable computing device, such as, a microprocessor, a mainframe computer, a digital signal processor, a portable computing device, a personal organizer, a device controller, a logic device (e.g., a programmable logic device configured to perform processing functions), a digital signal processing (DSP) device, or a computational engine within an appliance. In embodiments, the processor 832 includes one or more input devices (e.g., a keyboard and a mouse) and a display device.

The processor 832 can have one or more memory devices associated therewith to store data and information. The one or more memory devices can include any suitable type, including volatile and non-volatile memory devices, such as RAM (Random Access Memory), ROM (Read-Only Memory), EEPROM (Electrically-Erasable Programmable Read-Only Memory), flash memory, etc. In one embodiment, the processor 832 is adapted to execute programming stored upon a non-transitory computer readable medium 834 to perform various methods, processes, and modes of operations in a manner following principles of the present disclosure.

In embodiments, a defect detecting program 834 following principles of the present disclosure can be configured to implement an embodiment of a defect detection system according to principles of the present disclosure. In embodiments, the defect detecting program 834 includes a graphical user interface that can be displayed by the display device. The graphical user interface can be used to facilitate the inputting of commands and data by a user to the defect detecting program 834 and to display outputs generated by the defect detecting program 834.

The defect detecting program 834 can be stored upon any suitable computer-readable storage medium. For example, in embodiments, a defect detecting program 834 following principles of the present disclosure can be stored upon a hard drive, floppy disk, CD-ROM drive, tape drive, zip drive, flash drive, optical storage device, magnetic storage device, and the like.

In embodiments, the defect detecting program 834 can be configured to issue an alert that is displayed upon a display device via a graphical user interface, for example, when a defect condition, such as a crack or other surface defect, is detected. In embodiments, the defect detecting program 834 can issue a warning to at least one of an upstream station and a downstream station.

The cutting station 818 is disposed downstream of the forming station 815 along the machine direction 50. The cutting station 818 is arranged with respect to the conveyor 823 such that the conveyor 823 carries the cementitious board 821 past the cutting station 818. The cutting station 818 can include a knife configured to periodically cut the cementitious board 821 along the cross-machine direction 51 to define a series of board segments as the cementitious board 821 moves along the machine direction 50 past the cutting station 818. In embodiments, the knife can be a rotary knife as is generally known to those skilled in the art.

In embodiments, the system for manufacturing a cementitious board can include other components and stations. For example, in embodiments, the system can include a transfer system, including a board inverter; a kiln; and a bundler and taping station, all downstream of the cutting station.

In embodiments of a method of manufacturing a board following principles of the present disclosure, a defect detection system according to principles of the present disclosure is used to detect whether a defect condition is present during the continuous manufacture of the board. In embodiments, a method of manufacturing a board following principles of the present disclosure can be used with any embodiment of a defect detection system constructed according to principles discussed herein.

In one embodiment, a method of manufacturing a cementitious board includes conveying the cementitious board along a machine direction away from a forming station. The cementitious board has a pair of edges disposed in lateral spaced relationship to each other along a cross-machine direction, which is perpendicular to the machine direction. The edges of the cementitious board extend along the machine direction.

The imaging device, which is disposed downstream of the forming station along the machine direction, is used to generate image data within a field of view corresponding to a portion of the cementitious board as the cementitious board is conveyed past the imaging device. In embodiments, the field of view of the imaging device includes the edges of the cementitious board such that the image data includes edge data for both edges of the cementitious board, and the light beam that strikes the board extends along the cross-machine direction over the entire width of the board, which is measured from edge to edge of the board along the cross-machine direction.

The light source mounted in the fixture of the light assembly is operated to emit a light beam that strikes the board within the field of view of the imaging device. The fixture reflects at least a portion of the light beam emitted by the light source. In embodiments, the imaging device comprises a line scan camera, and the fixture is configured such that the light beam that strikes the board covers the field of view of the line scan camera.

In embodiments, the fixture comprises a U-shaped channel that includes a base and a pair of sidewalls respectively projecting from an end of the base. The light source is mounted to the base. The sidewalls each have a distal end, and the distal ends cooperate together to define an open outlet through which the light beam emitted by the light source passes. The sidewalls each have an internal reflective surface reflecting at least a portion of the light beam emitted by the light source.

Image data are transmitted from the imaging device to a controller. The controller is used to determine whether a defect condition has occurred using the image data and, in response to so determining a defect condition has occurred, to generate a control signal. In embodiments, the controller, in response to detecting the defect condition, issues at least one of an upstream signal to make an upstream manufacturing process adjustment and a downstream signal to initiate a board reject sequence.

All references cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for manufacturing a cementitious board, the cementitious board having a pair of edges, the system comprising:
a forming station, the forming station configured to form the cementitious board such that the cementitious board is within a predetermined thickness range;
a conveyor, the conveyor configured to convey the cementitious board along a machine direction away from the forming station such that the edges of the cementitious board extend along the machine direction and are disposed in lateral spaced relationship to each other along a cross-machine direction, the cross-machine direction being perpendicular to the machine direction;
a defect detection system, the defect detection system including an imaging device, a light assembly, and a controller,
the imaging device being disposed downstream of the forming station along the machine direction, the imaging device being positioned relative to the conveyor and being configured to generate image data within a field of view corresponding to a portion of the cementitious board as the cementitious board is conveyed past the imaging device,
the light assembly having a light source configured to generate a light beam and a fixture configured to receive the light source therein and to reflect at least a portion of the light beam emitted by the light source so that the light beam is projected onto the board within the field of view of the imaging device,
the controller being in operable arrangement with the imaging device to receive image data therefrom, the controller configured to generate a control signal in response to the image data meeting a defect condition.

2. The system for manufacturing according to claim 1, wherein the imaging device having a field of view with a cross-machine view distance measured along the cross-machine direction, the cross-machine view distance of the imaging device configured such that the image data includes edge data for both edges of the cementitious board, and wherein the light assembly has an axial length extending along the cross-machine direction, the axial length of the light assembly being greater than a width of the cementitious board measured along the cross-machine direction.

3. The system for manufacturing according to claim 2, wherein the imaging device comprises a line scan camera, and wherein the fixture is configured such that the light beam projected onto the board covers the field of view of the line scan camera.

4. The system for manufacturing according to claim 1, wherein the light assembly includes a mounting base within which the fixture is secured and at least one mounting clamp positioned at each end of the light assembly.

5. The system for manufacturing according to claim 1, wherein the imaging device and the light assembly are mounted within the conveyor and positioned so that the field of view of the imaging device includes the cover sheet of the board in contact with the conveyor.

6. The system for manufacturing according to claim 1, wherein the light source comprises a LED light strip.

7. The system for manufacturing according to claim 1, wherein the fixture is pivotably mounted so that an incident angle of the light beam striking the board can be varied.

8. The system for manufacturing according to claim 1, wherein the fixture comprises a U-shaped channel with a pair of sidewalls, the light source being mounted within the U-shaped channel, the sidewalls each having a distal end cooperating together to define an open outlet through which the light beam emitted by the light source mounted to the base of the fixture can pass, the sidewalls each having an internal reflective surface.

9. The system for manufacturing according to claim 8, wherein each of the internal reflective surfaces is generally planar and extends perpendicularly from the base.

10. The system for manufacturing according to claim 8, wherein a ratio of a height of the internal reflective surfaces of the sidewalls to a width of the base is greater than 1.

11. The system for manufacturing according to claim 8, wherein a ratio of a height of the internal reflective surfaces of the sidewalls to a width of the base is in a range from 1 to 7.

12. The system for manufacturing according to claim 8, wherein each of the internal reflective surfaces includes a distal tapered surface such that an outlet width of the open outlet is less than a width of the base.

13. The system for manufacturing according to claim 8, each of the internal reflective surfaces includes a distal tapered surface such that a ratio of an outlet width of the open outlet to a width of the base is in a range from 0.25 to less than 1.

14. The system for manufacturing according to claim 8, wherein each of the internal reflective surfaces has a parabolic shape such that an outlet width of the open outlet is greater than a width of the base.

15. The system for manufacturing according to claim 1, further comprising
a cutting station, the cutting station disposed downstream of the forming station along the machine direction, the cutting station arranged with respect to the conveyor such that the conveyor carries the cementitious board past the cutting station, the cutting station including a knife configured to periodically cut the cementitious board along the cross-machine direction to define a series in board segments as the cementitious board moves along the machine direction past the cutting station, wherein the imaging device is disposed between the forming station and the cutting station.

16. A method of manufacturing a cementitious board, the method comprising:
conveying the cementitious board along a machine direction away from a forming station, the cementitious board having a pair of edges, the edges disposed in lateral spaced relationship to each other along a cross-machine direction, the cross-machine direction being perpendicular to the machine direction, the edges of the cementitious board extending along the machine direction;
using an imaging device disposed downstream of the forming station along the machine direction to generate image data within a field of view corresponding to a portion of the cementitious board as the cementitious board is conveyed past the imaging device;
operating a light source mounted in a fixture to emit a light beam that strikes the board within the field of view of the imaging device, the fixture reflecting at least a portion of the light beam emitted by the light source;
transmitting image data from the imaging device to a controller;
using the controller to determine whether a defect condition has occurred using the image data and, in response to so determining, to generate a control signal.

17. The method according to claim 16, wherein the controller, in response to detecting the defect condition, issues at least one of an upstream signal to make an upstream manufacturing process adjustment and a downstream signal to initiate a board reject sequence.

18. The method according to claim 16, wherein the field of view of the imaging device includes the edges of the cementitious board such that the image data includes edge data for both edges of the cementitious board, and wherein the light beam that strikes the board extends along the cross-machine direction over the entire width of the board, measured from edge to edge of the board along the cross-machine direction.

19. The method according to claim 18, wherein the imaging device comprises a line scan camera, and wherein the fixture is configured such that the light beam that strikes the board covers the field of view of the line scan camera.

20. The method according to claim 16, wherein the fixture comprises a U-shaped channel with a pair of sidewalls, the light source being mounted within the U-shaped channel, the sidewalls each having a distal end cooperating together to define an open outlet through which the light beam emitted by the light source mounted to the base of the fixture can pass, the sidewalls each having an internal reflective surface reflecting at least a portion of the light beam emitted by the light source.
